(19) United States
(12) Patent Application Publication
(10) Pub. No.: US 2007/0023146 A1
(43) Pub. Date: Feb. 1, 2007

(54) Tire belt making machine strip alignment system

(76) Inventors: Jeffrey F. Bull, Tallmadge, OH (US); Frank A. Edwards, Uniontown, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/195,251

(22) Filed: Aug. 1, 2005

(51) Int. Cl. B29D 30/08

(52) U.S. Cl. 156/406.4

(57) ABSTRACT

In general the present invention provides an alignment assembly for aligning a strip before it is cut in a cutting station in a tire belt making machine, the alignment assembly including a guide that defines an axis, a surface adapted to support the strip adjacent to the guide, and an actuator adapted to move at least one of the guide toward the surface to contact an edge of the strip against the guide, thereby aligning the strip to the guide's axis.

### TECHNICAL FIELD

In general, the present invention relates to a tire belt making machine. More particularly, the present invention relates to a cutting station in a tire belt making machine. Most particularly, the present invention relates to a belt alignment system used in connection with the cutting station.

### BACKGROUND OF THE INVENTION

Tire belt making machines generally include an extruding station that produces a strip of elastomeric material that is transported to a cutting station where it is cut into plies that are spliced together to form a tire belt. To splice the plies together, they are placed on an indexing conveyor. After a ply is laid on the conveyor, it indexes a distance to receive the next ply. The index distance is based on the ply width and the type of splice used to join the plies. For example, when a butt splice is used, the conveyor indexes a distance substantially equal to the width of the ply so that adjacent plies lay next to each other without overlap. In some cases, lap splices may be used and the conveyor index would be less than the width of a strip.

Existing tire belt making machines rely heavily on an operator that monitors the strip width and splice quality to determine the indexing distance of the conveyor. The operator also controls the speed of the extruder and cooling station. Coordinating these activities to create a good splice requires great skill. To develop this skill, the operator generally needs to spend many hours working at the machine. Even highly skilled operators tend to operate the extruder at a slower than optimal speed to ensure good splices every time.

Recently, the applicants developed a tire making machine that decreases reliance on the operator by automating extruder speed, strip width monitoring, and indexing distance operations. While the automated tire belt making machine was able to make highly accurate adjustments of the index distance based on the strip width measurement taken by the machine, a few inaccurate splices were observed. It was discovered that since the strip entering the cutter was undergoing changes in its width, it was not always picked up in the same position as the previous strip. While the index distance reflected the strip width, the misalignment of incoming strips relative to each other resulted in poor splices. Consequently, there is a need for a system of aligning the strips before they are cut.

### SUMMARY OF THE INVENTION

In general the present invention provides an alignment assembly for aligning a strip before it is cut in a cutting station in a tire belt making machine, the alignment assembly including a guide that defines an axis, a surface adapted to support the strip adjacent to the guide, and an actuator adapted to move at least one of the guide toward the surface to contact an edge of the strip against the guide, thereby aligning the strip to the guide's axis.

The present invention further provides a cutting assembly for cutting a tire strip in a tire belt making machine, the cutting assembly including a cutter, a table upstream of the cutter, the table having a surface adapted to support the tire strip, where the surface is moveable relative to a guide located adjacent to the surface. The guide defines an axis and extends upward from the plane of the surface and extends sufficient to contact an edge of the strip. The cutting assembly further includes an actuator engageable with the surface and adapted to selectively move the surface toward the guide to contact the strip with guide and align the strip along the axis.

The present invention further provides a method for aligning the strip in a tire belt making machine before it is cut at a cutting station, the method including providing a guide that defines an axis upstream of the cutting station, and delivering the strip adjacent to the guide and moving the strip laterally to contact the guide and align it along the guide's axis.

The present invention further provides a tire belt making machine including an extruder that produces a strip, a cutting station adapted to cut the strip into plies, an index conveyor adapted to receive the plies after they are cut, and a controller in communication with a strip width monitor adapted to measure the strip width before a strip is cut, wherein said controller is adapted to move a ply on said index conveyor a distance that takes the measured strip width into consideration; and an alignment assembly located upstream of the cutter including a guide that defines an axis and a surface on which a portion of the strip is received before it is cut, and an actuator adapted to move said surface having said strip thereon toward said guide to contact the strip with the guide and align it along the axis.

### BRIEF DESCRIPTION OF THE DRAWINGS

FIG. 1 is a schematic elevational view of a tire making machine according to the concepts of the present invention;

FIG. 2 is a top plan view of a prior art cutting station;

FIG. 3 is a top plan view of an alignment system according to the concepts of the present invention;

FIG. 4 is a front elevational view of an alignment system similar to the one depicted in FIG. 3;

FIG. 5 is a left side elevational view of an alignment system similar to the one depicted in FIG. 3;

FIG. 6 is an enlarged top plan view of an alignment system according to the concepts of the present invention having a surface for supporting a tire strip in a first position relative to a guide that extends parallel to the flow of the strip; and

FIG. 7 is an enlarged top plan view similar to the one shown in FIG. 6 depicting the surface in a second position, where the surface has moved toward the guide to align the tire strip against the guide.

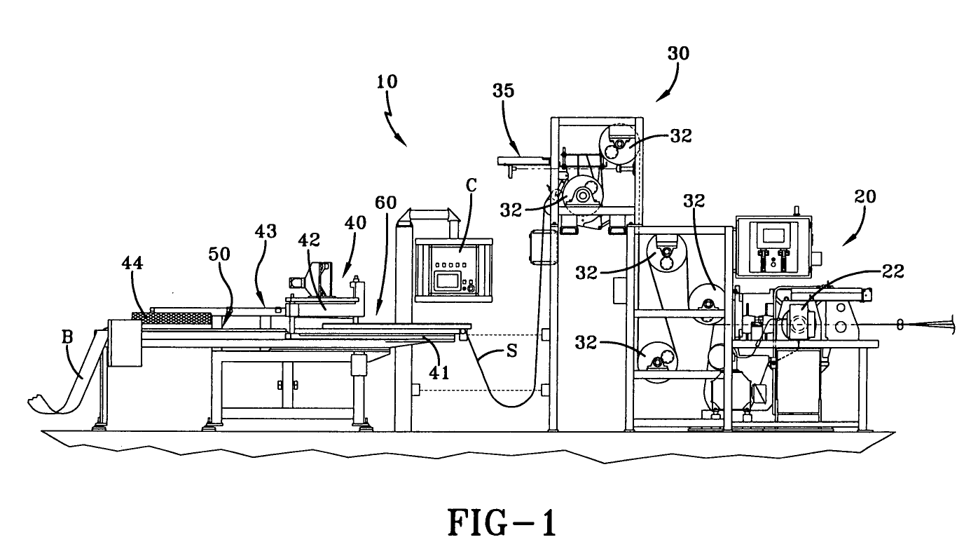

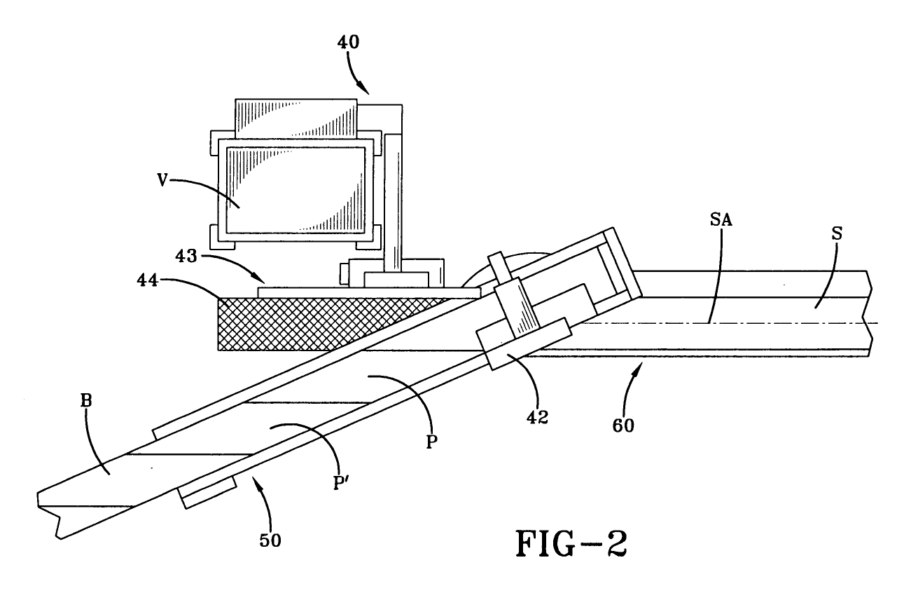

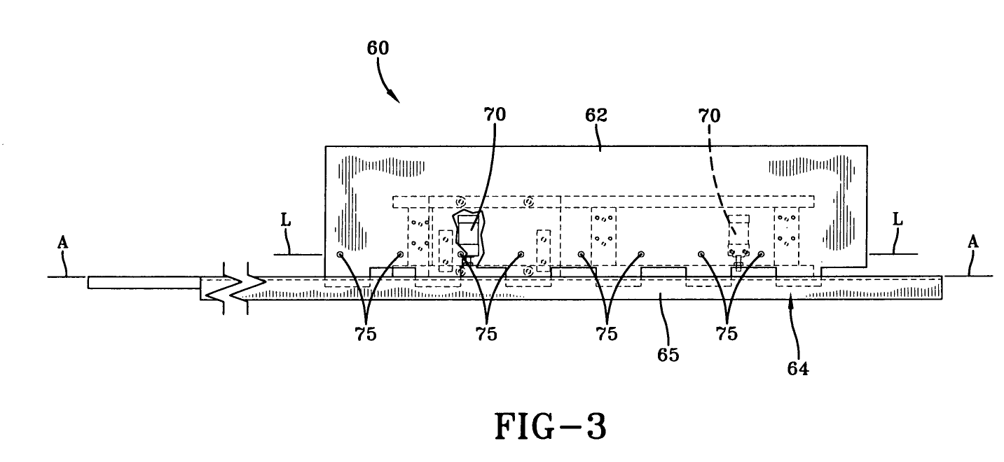

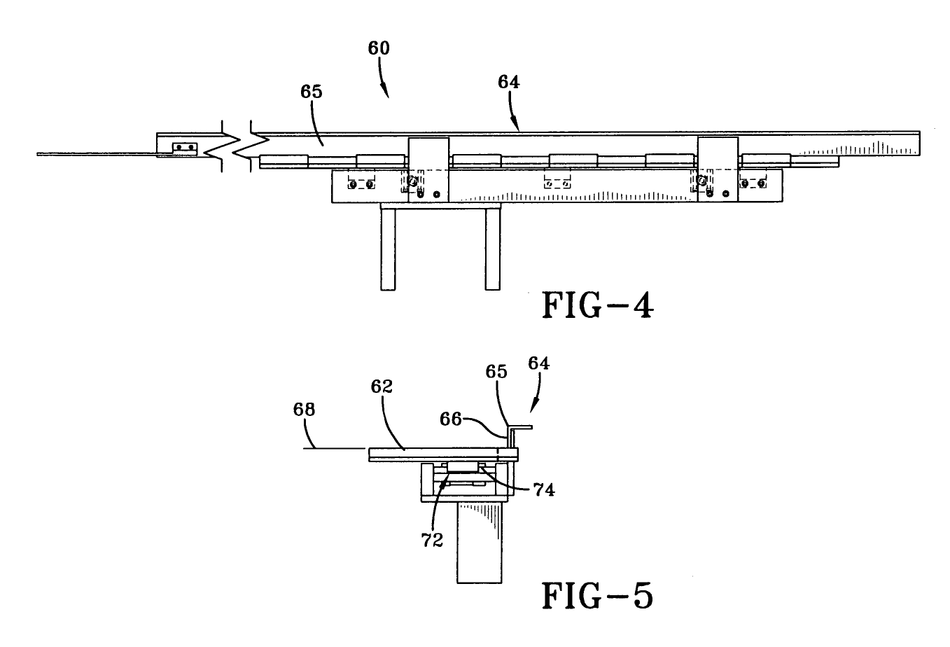

### DETAILED DESCRIPTION OF THE INVENTION

A tire belt making machine according to the concepts of the present invention is depicted in the drawings and generally referred to by the number 10. Tire belt machine 10 generally includes an extruder assembly, generally indicated by the number 20, a cooling station, generally indicated by the number 30, and a cutting station, generally indicated by the number 40, and an exit conveyor, generally indicated by the number 50. The finished belt may be taken up from the exit conveyor 50 on drums or other processing may occur as is familiar to those of ordinary skill in the art.

In making a tire belt, the extruder assembly 20 includes an extruder 22 that produces a tire strip S in a generally continuous fashion. The extruder may incorporate fibers or other reinforcement into the strip S. After exiting the extruder, the tire strip may be run through cooling station 30, which may include a series of drums 32 on which the tire strip S is transported until it has cooled to a point where further processing may occur. Since the tire strip S is generally dimensionally stable as it exits the cooling station 30, the cooling station 30 may include a strip width monitor, generally indicated by the number 35, that measures the width of the strip S and reports it to a controller C. After strip S has cooled, it is delivered to the cutting station 40 where it is cut into plies P.

In general, the strip S is laid onto a table, generally indicated by the number 41, a selected length of strip S is drawn past a cutter, generally indicated by the number 42, and the cutter 42 is then activated to cut that selected length of strip S into a ply P. Transport of the strip past the cutter 42 may occur in any known manner. For example, a pick-up assembly, generally indicated by the number 43 may be used to pull the strip S past the cutter 42 and on to a conveyor 50. Vacuum pick-up 43 includes a vacuum head 44 that moves over a selected portion of the tire strip S while it is lying on the table 41. A vacuum is then applied to the vacuum head 44 to pick-up the selected portion of the strip S and then vacuum head 44 is moved to draw the strip S past the cutter 42. In the example shown, the vacuum head 44 lays the selected portion of strip S on the index conveyor 50, and the cutter 42 is activated to cut that portion into a ply P. In the example shown, vacuum head 44 generally moves in a straight line substantially parallel to the axis of the strip S.

Based on the strip width measurement and the desired splice, the controller C indexes the conveyor 50 a selected distance before the next ply P is cut. In this way successive plies are laid on the conveyor 50 and joined to form a belt B.

Since indexing of the conveyor 50 is generally based on the edge-to-edge dimension (width) of the tire strip S, to ensure accurate placement of the strip S on the conveyor 50, the present invention aligns at least one edge of strip S along an axis A before the strip S is cut. To that end the present invention includes an alignment assembly, generally indicated by the number 60 in the drawing. In the example shown, the alignment assembly 60 is used in connection with the cutting station 40 to align the tire strip S before it is cut. In general, alignment assembly 60 includes a surface 62 on which the strip S rests before entering the cutter. The alignment assembly 60 also includes a guide 64 that defines an axis A to which the strip S is aligned. The guide 64 may be any structure suitable for defining axis A. For example two or more contact points may be provided to define axis A. In the example shown, guide 64 includes a fence extending along one side of table 61. The fence has a face 66 that contacts the strip S. In operation, alignment assembly 60 brings the strip S and guide 64 into contact to align strip S along axis A. In the example shown, the surface 62 moves relative to a stationary guide 64 to bring the strip S into contact with the guide 64. It will be appreciated that the guide 64 or both the guide 64 and surface 62 may be moved to align the strip S.

An actuator, generally indicated by the number 70, is provided to move the surface 62. Any actuator capable of moving the surface 62 relative to the guide 64 to cause the portion of strip S on surface 62 to contact the guide 64 may be used. In the depicted example, a linear actuator, such as an air cylinder, is used. This example is not to be considered limiting. The surface 62 may be mounted on suitable bearings 72 such as, for example, rails 74 oriented in the desired direction of travel for the surface 62. In the example shown, the surface 62 travels generally perpendicularly to the guide 64.

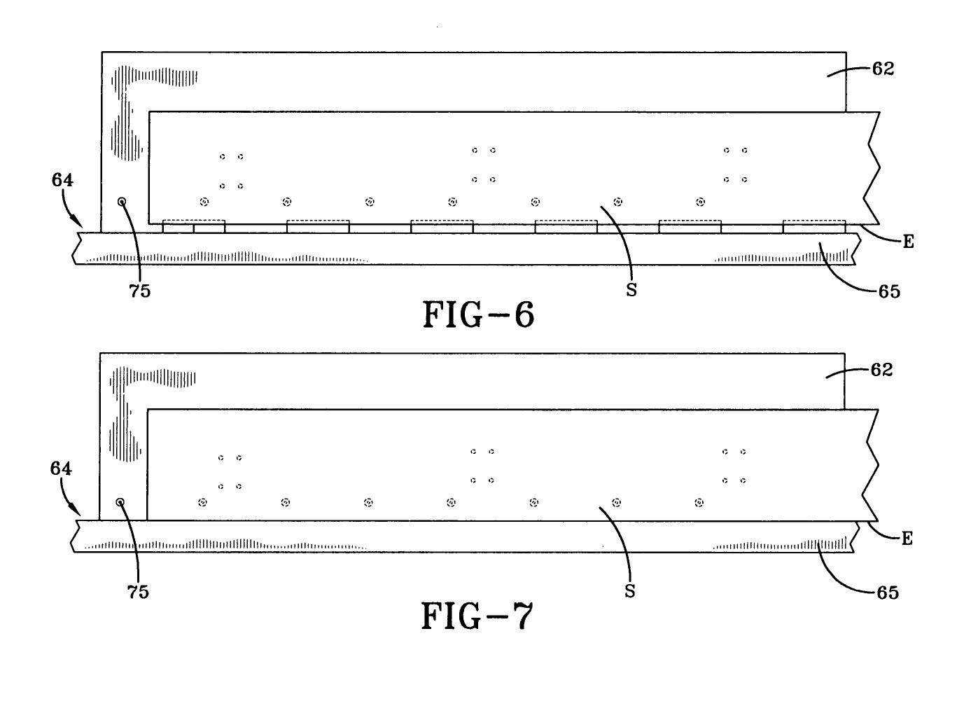

As best shown in FIGS. 6 and 7, the surface 62 may be in a first position (FIG. 6) when the strip S is initially placed on the surface 62. To align the strip S with the guide 64, the surface 62 shifts laterally to bring the strip S into contact with guide 64 (FIG. 7). After the strip S is cut, the surface 62 returns to the first position to align the next incoming portion of strip S. The surface 62 may be returned by the actuator 70 or a biasing system may be used to bias the surface 62 toward the first position (FIG. 6), such that release of the actuator would allow the surface 62 to return to the first position (FIG. 6).

To better hold the strip S on the surface 62, a vacuum may be applied to the surface 62 to draw the strip S against the surface 62. For example, one or more openings 75 may be defined within the surface 62 and connected to a vacuum source. The openings 75 may be formed in any arrangement and at any location on the surface beneath the tire strip S. In the example shown, plural openings 75 are located near the guide 64 to better hold the edge of the strip S that is being aligned along the guide 64. As shown, the openings 75 may be aligned along a common line extending parallel to the guide 64.

In operation, the extruded strip S arrives at the table 61 and is provided onto the surface 62 before entering the cutter 42. Surface 62 moves toward the guide 64 to cause the strip S to contact the guide 64 and align the strip S along axis A. With the strip S so aligned, operation of the cutting station 42 continues in an ordinary fashion. The vacuum assembly 43 picks up the selected portion of the strip S to be cut and moves it to the conveyor 50. After the strip S has been moved, the cutter 42 is activated to cut the strip S into a ply P. After the cut has been made, the alignment assembly 60 aligns the strip S against the guide 64 and the process is repeated so that each strip S is aligned along a common axis A before it is cut. With the strip S aligned, the conveyor 50 may index a distance corresponding to the strip width as measured by the strip width monitor 35 and reported to the controller C. With the strips aligned along a common axis A, the indexing of the conveyor according to the strip width results in accurate placement of the subsequent ply relative to the ply on the conveyor. As a result, better splices are achieved improving overall belt quality.

It will be appreciated that an alignment system according to the concepts of the present invention may also be used in existing machines to aid the operator. To that end the alignment assembly 60 or a cutting station 30 including an alignment assembly according to the concepts of the present invention may be retrofit to existing tire belt making machines.

In accordance with the patent statutes only one embodiment of the present invention is depicted. Changes and modifications may be made to the depicted embodiment without departing from the present invention, and, therefore, to appreciate the scope of the present invention, reference should be made to the attached claims.

What is claimed:

1. An alignment assembly for aligning a strip before it is cut in a cutting station in a tire belt making machine, the alignment assembly comprising: a guide defining an axis; a surface adapted to support the strip adjacent to the guide, said surface and said guide being movable relative to each other to contact an edge of the strip against the guide and an actuation adapted move at least one of said guide and said surface

2. The alignment assembly of claim 1, wherein said guide is fixed and said surface is moveable relative to said guide.

3. The alignment assembly of claim 2 wherein said actuator is operatively attached to said surface, and wherein said surface is supported on a bearing adapted to allow said surface to move substantially perpendicular to said guide.

4. The alignment assembly of claim 3, wherein said actuator is an air cylinder.

5. The alignment assembly of claim 3, wherein said bearing includes a pair of rails.

6. The alignment assembly of claim 1 further comprising a vacuum assembly including an opening defined in said surface, said opening being connected to a vacuum source.

7. The alignment assembly of claim 6, wherein said opening is located near said guide.

8. The alignment assembly of claim 6, wherein said opening extends parallel to said guide.

9. The alignment assembly of claim 6, wherein said actuator is adapted to move perpendicular to said guide.

10. A cutting assembly for cutting a tire strip in a tire belt making machine, the cutting assembly comprising a cutter; a table upstream of said cutter, said table having a surface adapted to support the tire strip, said surface being movable relative to a guide located adjacent to said surface, said guide defining an axis wherein said guide extends upward from the plane of said surface an extent sufficient to contact an edge of the strip; an actuator engagable with said surface and adapted to selectively move said surface toward said guide to each other to contact the strip with the guide and align the strip along the axis.

11. The cutting assembly of claim 10 further comprising a vacuum assembly including a vacuum source selectively connected to at least one opening in said surface.

12. The cutting assembly of claim 11, wherein said suction assembly includes plural openings defined in said surface arranged along a line parallel to said guide and near an edge of such surface closest to said guide.

13. The cutting assembly of claim 10, wherein said actuator is an air cylinder.

14. The cutting assembly of claim 10, wherein said guide is a fence.

15. The cutting assembly of claim 13, wherein said fence extends substantially the entire length of said table.

16. The cutting assembly of claim 10, further comprising a pick-up assembly adapted to pull a selected portion of the strip past the cutter, said pick-up assembly including a head adapted to move parallel to the guide.

17. The cutting assembly of claim 16, wherein said guide includes a fence, wherein said pick-up head is moveable along said fence.

18. A method for aligning a strip in a tire belt making machine before it is cut at a cutting station, the method comprising: providing a guide that defines an axis upstream of the cutting station; and
delivering the strip adjacent to the guide and moving the strip laterally to contact the guide.

19. The present invention further provides a tire belt making machine including an extruder that produces a strip, a cutting station adapted to cut the strip into plies, an index conveyor adapted to receive the plies after they are cut, and a controller in communication with a strip width monitor adapted to measure the strip width before a strip is cut, wherein said controller is adapted to move a ply on said index conveyor a distance that takes the measured strip width into consideration; and an alignment assembly located upstream of the cutter including a guide that defines an axis and a surface on which a portion of the strip is received before it is cut, and an actuator adapted to move said surface having said strip thereon toward said guide to contact the strip with the guide and align it along the axis.
